(19) United States
(12) Patent Application Publication
(10) Pub. No.: US 2016/0288217 A1
(43) Pub. Date: Oct. 6, 2016

(54) PIPE BORING APPARATUS AND ASSOCIATED METHOD

(71) Applicant: Murphy Pipe & Civil IP Pty Ltd, Albion (AU)

(72) Inventors: James Francis Darcy, ALBION (AU); James Graham Campbell, ALBION (AU)

(21) Appl. No.: 14/676,199

(22) Filed: Apr. 1, 2015

(51) Int. Cl. B23B 29/14; B23B 5/08

(52) U.S. Cl. CPC B23B 29/14; B23B 5/08; B23B 2215/72; B23B 2226/61

(57) ABSTRACT

A pipe boring apparatus for boring an end of a pipe. The pipe boring apparatus can include a driven rotating head and a pipe borer. The pipe borer can include a body that is connected to the rotating head, a floating section that is movable with respect to the body, a biasing member that is connected to the body and to the floating section, a follower for following an outer surface of a pipe, and a cutter for cutting the internal surface of the pipe. A space between the follower and the cutter may be fixed in use.

### FIELD OF THE INVENTION

This invention relates to a pipe boring apparatus and associated method. In particular, the invention relates to a pipe boring apparatus for boring an end of a polyethylene pipe.

### BACKGROUND OF THE INVENTION

The advantages provided by underground pipes are well recognized by people in the various industries, such as telecommunication, oil, water and gas. However, the laying of underground pipes can be expensive and time consuming. This is especially the case when the terrain provides substantial landscape obstacles such as undulating ground and rivers, in addition, the client requires the pipes to be buried deep into the ground. The development of the plough system (known in the industry as the “SpiderPlow, Foeck Plough or Spider Plough”) has revolutionized the laying of underground pipe. The plough system consists of a winch vehicle which is attached via a cable to a plough vehicle. The plough system can lay polyethylene pipe very quick in a variety of terrain.

When a pipeline is laid, the outer diameter of the pipe generally does not change. However, the internal diameter of the pipe often changes to increase or decrease the wall thickness of the pipe. The increase in wall thickness of the pipe is usually required when the pipe is likely to encounter increased forces such as when it is located under a road or watercourse.

Polyethylene pipes that are laid using a plough vehicle are often joined using a fast fusion welding machine. Polyethylene pipe that is joined through fusion welding normally creates a butt joint. A butt joint is formed by holding the two sections of pipe rigidly using a two pairs of jaws which form part of the fusion welding machine. The two ends of the pipes are faced to square the ends of the pipes and prepare the pipes for welding. The ends of the pipes are then heated above their melting point using a heating element. The pipes are then pushed together using the jaws which forces the two melted faces of the respective pipes together to fuse into each other and hence form the butt joint. Fusion welding usually creates a joint that is as strong as or stronger than the parent material and is very reliable when used on pipes that have the same wall thickness. However, fusion welding does not work well with pipes that have different wall thickness. Therefore, when two pipes of a different wall thickness needs to be joined together, a prefabricated, transition section of pipe is often used. The transition section of pipe has two ends of different wall thickness which reflect the wall thickness of each of the pipes that the transition section of pipe is to be joined.

A transition section of pipe is undesirable as the transition section must be preordered and premade and must be ready on-site when needed. Further, the fusion welding of this transition section is time consuming and cumbersome due to the number of welds required.

Australian Patent Application No. 2013202652 discloses a cutting tool that is used to produce transition sections. The cutting tool works in cooperation with jaws of a fusion welding machine to bore the end of a pipe to a desired thickness. The pipe is held by one set of jaws of the fusion welding machine whilst the cutting tool is held by the other end of the cutting tool. The use of the cutting tool in conjunction with the fusion welding works well for pipes of a relatively small wall thickness. However, for pipes of a greater wall thickness that are not a true round shape, the jaws of the fusion welding machine often do not have sufficient force to squeeze the pipe back into a round shape. Accordingly, for pipes using this cutting tool, the end wall thickness after the cut will not be even along the circumference of the end of the pipe. The reference to any prior art in this specification is not, and should not be taken as, an acknowledgement or any form of suggestion that the prior art forms part of the common general knowledge.

### OBJECT OF THE INVENTION

It is an object of the invention to overcome and/or alleviate one or more of the above disadvantages and/or provide the consumer with a useful or commercial choice.

### SUMMARY OF THE INVENTION

In one form, the invention resides in a pipe boring apparatus for boring an end of a pipe, the pipe boring apparatus comprising:
a driven rotating head;
a pipe borer including:
   a body that is connected to the rotating head;
   a floating section that is movable with respect to the body;
   a biasing member that is connected to the body and to the floating section;
   a follower for following an outer surface of a pipe, the follower connected to the floating section; and
   a cutter for cutting the internal surface of the pipe, the cutter connected to the floating section,
   wherein a space between the follower and the cutter is fixed in use.

The driven rotating head normally forms part of a lathe or other turning machine.

The pipe borer is normally removably attached to the driven head.

The body usually contains a floating section chamber for location of the floating section.

The floating section is normally located within the body. The floating section normally reciprocates with respect to the body.

The follower normally includes a guide roller that contacts the pipe.

The cutter normally includes a cutter blade. Normally the cutter blade is adjustable to cater for different size pipes.

When the apparatus is not in use, the space between the follower and the cutter may be varied by moving either the follower or the cutter with respect to the floating section.

The biasing member is typically in the form of a spring. The tension in the spring may be adjusted. Typically the tension in the spring is adjusted by a load adjuster that varies the allowed travel of the spring.

A travel adjuster may be used to limit the travel of the floating section with respect to the body. The travel adjuster may be an adjustable stop located within the floating section chamber.

The pipe boring machine may also include a holder for holding a pipe. Suitably, the holder includes at least jaw. Normally, the holder includes at least one pair of jaws.

The jaws may be moved between an open position and a closed position. Once in the closed position, the jaws may be moved between this closed position and clamping position to clamp a pipe located within the jaws.

The jaws may be mechanically or hydraulically driven using a controller. The controller may be used to move the jaws between an open position, a closed position and a clamping position. Further, a deadman switch may be form part of the controller so that a users cannot become entangled within the jaws.

In yet another form, the invention resides in a pipe borer comprising:
a body that is connected to the rotating head;
a floating section that is movable with respect to the body;
a biasing member that is connected to the body and to the floating section;
a follower for following an outer circumference of a pipe, the follower connected to the floating section; and
a cutter for cutting the internal circumference of the pipe, the cutter connected to the floating section,
wherein a space between the follower and the cutter is fixed in use.

In anther form, although not necessarily the only or broadest form, the invention resides a method of boring a pipe, the method including the steps of:
engaging a follower with an outer surface of a pipe so that the follower followers the outer surface of the pipe as it rotates around the pipe; and
engaging a cutter with an internal surface of the pipe to cut the pipe, the spacing between the cutter and the follower being fixed in use so that a wall thickness of the pipe is consistent around the diameter of the pipe.

Further forms and features of the present invention will become apparent from the following detailed description.

### BRIEF DESCRIPTION OF THE DRAWINGS

An embodiment, by way of example only, will now be described with reference to the accompanying drawings in which:

FIG. 1 is a side view of a pipe borer according to an embodiment of the invention;

FIG. 2 is a front view of a pipe borer according to an embodiment of the invention;

FIG. 3 is a sectional side view of a pipe borer according to an embodiment of the invention;

FIG. 4 is a detailed view of the biasing member and load adjuster of the pipe borer of FIG. 3;

FIG. 5A is a perspective view of a two pair of jaws in an open position;

FIG. 5B is a perspective view of a two pair of jaws in an closed position;

FIG. 5C is a perspective view of a two pair of jaws in an clamp position;

FIG. 6 is a perspective view of a controller;

FIG. 7 is a sectional side view of a pipe before it is bored by the pipe borer;

FIG. 8 is a sectional side view of a pipe engaging a follower of the pipe borer; and

FIG. 9 is a sectional side view of a pipe being bored by the pipe borer.

### DETAILED DESCRIPTION OF THE PREFERRED EMBODIMENT

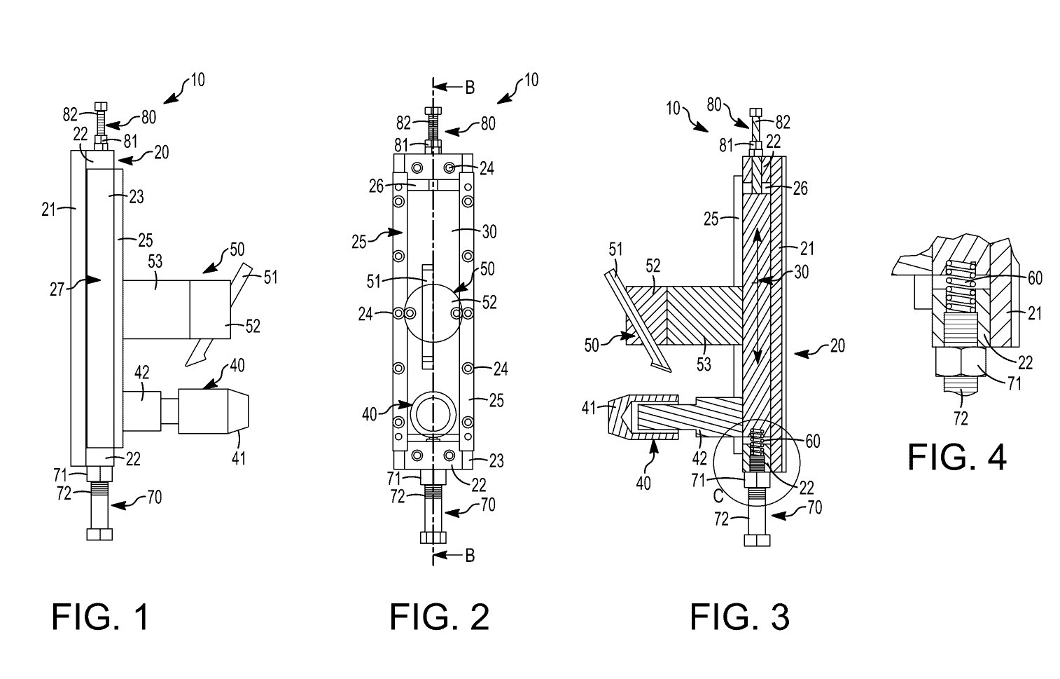

FIGS. 1 to 4 shows a pipe borer 10 that is used to expand the internal diameter of a pipe by cutting the internal wall of the pipe. The pipe borer 10 is formed from a body 20, a floating section 30, a follower 40, a cutter 50, a biasing member 60, load adjuster 70, travel adjuster 80, jaws 90 and controller 100.

The body 20 is formed from a rear wall 21, two end walls 22 and two side walls 23. The two end walls 22 are attached to respective ends of the rear wall 21 via fasteners 24. The two side walls 23 are attached to respective sides of the rear wall 21 via fasteners 24. Two slide clamps 25 are attached to respective side walls 23 via fasteners 24. The slide clamps 25 are wider than the side walls 23 so that the slide clamps 25 extend past respective edges of the side walls 23. The rear wall 21, end walls 22, side walls 23 and slide clamps 24 form a floating section chamber 26. A grease point 27 may be located through a side wall 23 to lubricate the floating section chamber 26.

The floating section 30 is located within the floating section chamber 26 of the body 20. The floating section 30 is smaller than the floating section chamber 26 and hence can reciprocate within the floating section chamber 26. The floating section 30 is in the form of a solid rectangular block. However, it would be appreciated by a person skilled in the art that the floating section may be formed from other shapes such a U-shaped.

The follower 40 is used to follow the outer wall of a pipe. The follower 40 includes a guider roller 41 and a roller mount 42. The guider roller 41 is rotatably mounted to the roller mount 42 to allow rotation of the guide roller 41. The guide roller 41 is tapered towards one end. The roller mount 42 is welded to the floating section 30. However it should be appreciated that the roller mount 42 may be removably attached to the floating section 30. Further, it would be appreciated by a person skilled in the art that the position of the roller mount 42 with respect to the floating section 30 may be changed.

The cutter 50 is used to cut the internal wall of the pipe. The cutter 50 includes a cutter blade 51, cutter head 52 and cutter mount 53. The cutter blade 51 is adjustably mounted within cutter head 52. The cutter head 52 is removable attached to the cutter mount 53. The cutter mount 53 is welded to the floating section 30. However, it should be appreciated that the cutter mount 53 may be removably attached to the floating section 30. Further, it would be appreciated by a person skilled in the art that the position of the cutter mount 53 with respect to the floating section 30 may be changed.

The biasing member 60 is used control the movement of the floating section 30 with respect to the body 20. The biasing member 60 in this embodiment is in the form of a helical spring 60. The helical spring 60 is connected to one end of the floating section 30 and an end wall of the body 20. A load adjuster 70 is attached to the spring 60 that enables the load on the spring 60 to be varied. The load adjuster 70 is in the form of a nut 71 and a bolt 72, with the bolt 72 extending through an end wall 22 and the nut 71 located over the bolt 72 and engaging the end wall 22. The load on the spring 60 is changed by rotating the bolt 72 which allows the spring to compress or retract.

A travel adjuster 80 is located on the body 20 to limit the amount of travel of the floating section 30 within the floating section chamber 26. The travel adjuster 80 is located through a end wall 22 of the body 20 opposite the load adjuster 70. The travel adjuster 80 is in the form of a nut 81 and a bolt 82, with the bolt 82 extending through the end wall 22 and the nut 81 located over the bolt 82 and engaging the end wall 22. The travel adjuster 80 operates by rotating the bolt 82 to change the depth in which the bolt 82 is located within the floating section chamber 26.

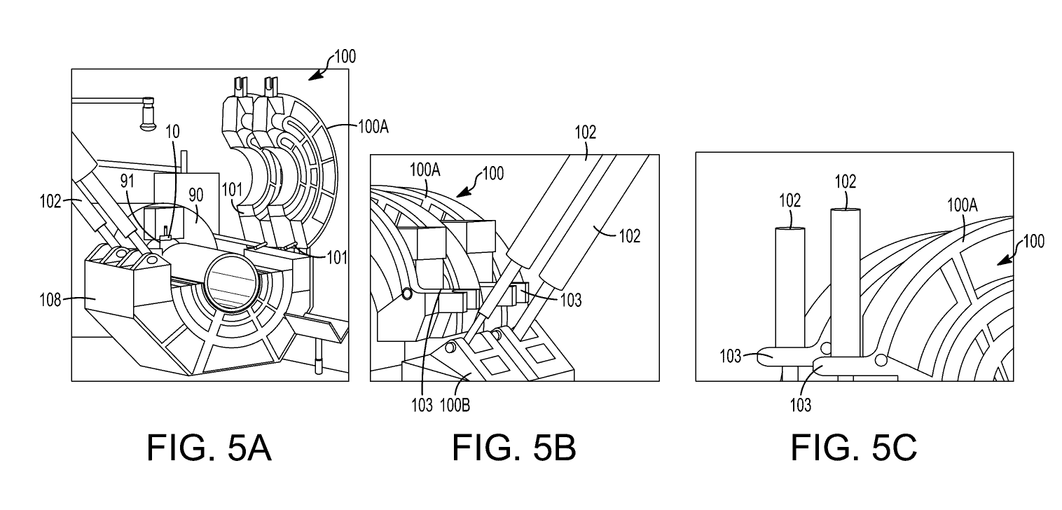

FIG. 5A shows the pipe borer 10 mounted to a lathe 90 that has a rotating head 91. Two pair of jaws 100 are located in front of the lathe 90. Each pair of jaws 100 is moveable between an open position shown in FIG. 5A and a closed position shown in FIG. 5B. Each of the pair of the jaws 100 is move via a hydraulic ram 101 between the open and closed position. When in the closed position, each of the pair of jaws 100 can be moved from the closed position to a clamp position as shown in FIG. 5C. In order to move each of the pairs of jaws 100 from the closed position to the clamp position, a hydraulic ram 102 is which is pivotally mounted to a bottom jaw 100A, is moved so that is positioned over a land of the top jaw 100B. The hydraulic ram is then retracted to so that the hydraulic ram engages the land 103 on the top jaw 100B to rotate the top jaw 100B toward the bottom jaw 100A moving the jaws from a closed position to a clamp position.

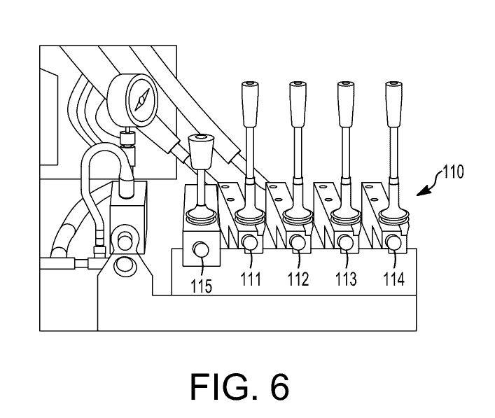

A controller 110, shown in FIG. 6 is used to control the extension and retraction of the hydraulic rams 102 and 102. The controller 110 uses four valves (not shown) controlled by four levers 111,112,113,114. The first pair of levers 111 and 112 is used to control hydraulic rams 101 respectively on the left and right hand pairs of jaws 100 to move the jaws between the open position and the closed position and visa versa. The second pair of levers 113 and 114 is used to control hydraulic rams 102 respectively on the left and right hand pairs of jaws 100 to move the jaws between the closed position and the clamp position and visa versa. A deadman value (not shown) is controlled by a deadman lever 115 forms part of the controller which prevents the operation of the hydraulic rams 101 and 102 unless the deadman lever is activated. When the deadman lever 115 and deadman valve are activated the remaining four levers to become operable 111, 112, 113, 114 to move the hydraulic rams 101 and 102. The deadman valve and deadman lever 115.

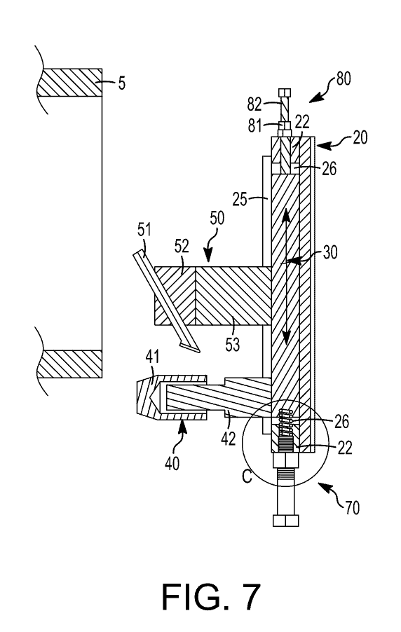

In use the pipe borer 10 is mounted to a lathe 90 (or the like apparatus) that has a rotating head 91. A pipe 5 is located within the two pairs of jaws 100 and the jaws are moved to the clamp position as described above. The pipe borer 10 is attached to the rotating head 91 so that the pipe 5 that is to be cut will fit within the space between the cutter 50 and follower 40. The pipe borer 10 is then moved towards to pipe 5 as shown in FIG. 7. However, it is envisaged that the pipe 5 may be moved toward the pipe 5 borer.

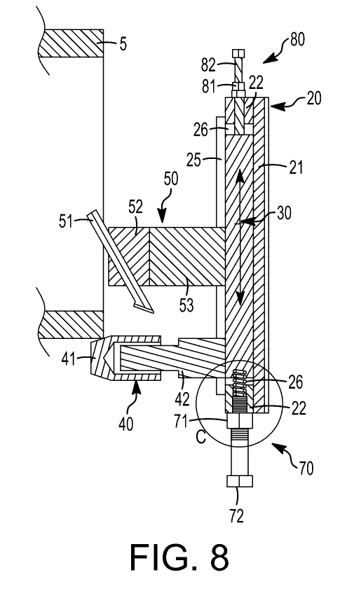

When cutting is commenced, normally the first contact point of the pipe 5 will be the tapered edge of the guide roller 41 as shown in FIG. 8. The continuous movement of the pipe borer 10 toward the pipe 5 will cause the floating section 30 to move within the floating section chamber 26 against the spring 60. Due to the bias of the spring 60, the guide roller 41 rolls around the outer surface of the pipe 5 following the outer surface of the pipe 5.

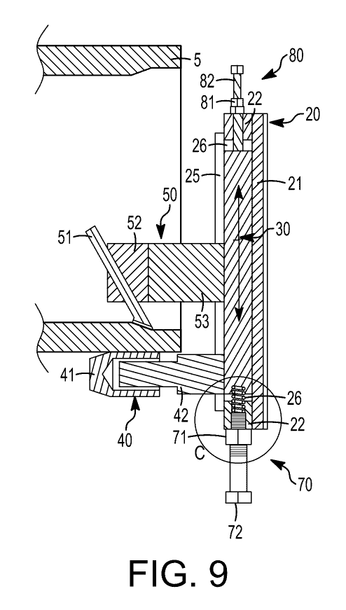

As the rotating head with pipe borer 10 moves further toward the pipe 5, the cutter blade 51 of the cutter 50 will commence cutting of the internal surface of the pipe 5 thereby reducing the wall thickness of the pipe adjacent the end of the pipe 5. This cutting continues until the required depth has been cut as shown in FIG. 9.

The pipe boring apparatus and the associated pipe borer provide and quick and simple way in which a pipe that is not round can be bored and have a consistent wall thickness.

In this specification, the terms “comprise”, “comprises”, “comprising” or similar terms are intended to mean a non-exclusive inclusion, such that a system, method or apparatus that comprises a list of elements does not include those elements solely, but may well include other elements not listed.

The reference to any prior art in this specification is not, and should not be taken as, an acknowledgement or any form of suggestion that the prior art forms part of the common general knowledge.

It should be appreciated that various other changes modifications may be made to the embodiment described with that departed from the spiritual scope of the invention.

1. A pipe boring apparatus for boring an end of a pipe, the pipe boring apparatus comprising:
a driven rotating head;
a pipe borer including:
a body that is connected to the rotating head;
a floating section that is movable with respect to the body;
a biasing member that is connected to the body and to the floating section;
a follower for following an outer surface of a pipe, the follower connected to the floating section; and
a cutter for cutting the internal surface of the pipe, the cutter connected to the floating section,
wherein a space between the follower and the cutter is fixed in use.

2. The pipe boring machine of claim 1 wherein the driven rotating head normally part of a lathe.

3. The pipe boring machine of claim 1 wherein the body contains a floating section chamber for location of the floating section.

4. The pipe boring machine o of claim 3 wherein the floating section is normally located within the body.

5. The pipe boring machine of claim 4 wherein the floating section reciprocates with respect to the body.

6. The pipe boring machine of claim 1 wherein the follower includes a guide roller to contact a pipe.

7. The pipe boring machine of claim 1 wherein the cutter includes a cutter blade.

8. The pipe boring machine of claim 7 wherein the cutter blade is adjustable.

9. The pipe boring machine of claim 1 wherein when the apparatus is not in use, the space between the follower and the cutter is able to be varied by moving either the follower or the cutter with respect to the floating section.

10. The pipe boring machine of claim 1 wherein the biasing member is in the form of a spring.

11. The pipe coring machine of claim 10 wherein the tension in the spring is adjusted by a load adjuster that varies the allowed travel of the spring.

12. The pipe boring machine of claim 1 wherein a travel adjuster is used to limit the travel of the floating section with respect to the body.

13. The pipe boring machine of claim 1 wherein the pipe boring machine includes a holder for holding a pipe.

14. The pipe boring machine of claim 13 wherein the holder includes at least one pair of jaws.

15. The pipe boring machine of claim 14 wherein the jaws may be moved between an open position, a closed position and a clamping position.

16. The pipe boring machine of claim 14 a controller may be used to move the jaws between an open position, a closed position and a clamping position.

17. The pipe boring machine of claim 14 wherein a deadman switch forms part of the controller.

18. A pipe borer comprising:
a body that is connected to the rotating head;
a floating section that is movable with respect to the body;
a biasing member that is connected to the body and to the floating section;
a follower for following an outer circumference of a pipe, the follower connected to the floating section; and
a cutter for cutting the internal circumference of the pipe, the cutter connected to the floating section,
wherein a space between the follower and the cutter is fixed in use.

19. A method of boring a pipe, the method including the steps of:
engaging a follower with an outer surface of a pipe so that the follower followers the outer surface of the pipe as it rotates around the pipe; and
engaging a cutter with an internal surface of the pipe to cut the pipe, the spacing between the cutter and the follower being fixed that a thickness of the pipe is consistent around the diameter if the pipe.
